(19) United States
(12) Patent Application Publication
(10) Pub. No.: US 2012/0198334 A1
(43) Pub. Date: Aug. 2, 2012

(54) METHODS AND SYSTEMS FOR IMAGE SHARING IN A COLLABORATIVE WORK SPACE

(75) Inventors: Nikolay Surin, San Francisco, CA (US); Tara Lemmey, San Francisco, CA (US); Stanislav Vonog, San Francisco, CA (US)

(73) Assignee: Net Power and Light, Inc., San Francisco, CA (US)

(21) Appl. No.: 13/316,868

(22) Filed: Dec. 12, 2011

Related U.S. Application Data
(63) Continuation-in-part of application No. 13/270,125, filed on Oct. 10, 2011.
Application No. 13/270,125 is a continuation-in-part of application No. 12/564,010, filed on Sep. 21, 2009.
(60) Provisional application No. 61/432,400, filed on Jan. 13, 2011.
(60) Provisional application No. 61/098,682, filed on Sep. 19, 2008.

(51) Int. Cl. G06F 3/048; G06F 3/16; G09G 5/00

(52) U.S. Cl. 715/716; 715/753; 345/661

(57) ABSTRACT

The present invention contemplates a variety of improved methods and systems for image sharing within a collaborative work space. One embodiment provides sophisticated GUI as a backdrop supporting a collaborative work space where a plurality of participants can interact with and view a presentation of a set of images, optionally with an audio background. The plurality of participants each engages with a local device having a local instantiation of the collaborative work space. In one embodiment, the local instantiation of the collaborative work space is a display block, and the GUI provides display stacks which include image content. A participant selecting and dragging the image content into the display block initiates the presentation of the set of images, which may be a slide show displayed on all active display instantiations of the collaborative works space.

### BACKGROUND OF INVENTION

The present application is a continuation-in-part application to U.S. patent application Ser. No. 13/270,125, entitled “Methods and Systems For Providing a Graphical User Interface”, filed on Oct. 10, 2011, and Ser. No. 12/564,010, entitled “Method and System for Distributed Computing Interface”, filed on Sep. 21, 2009, and claims the benefit of and priority to U.S. Provisional Patent Application Nos. ______, entitled “Methods and Systems for Providing a Graphical User Interface”, filed on Oct. 7, 2011, and 61/098,682 entitled “Method and System for Distributed Computing Interface for Sharing, Synchronizing, Manipulating, Storing, and Transporting Data”, filed on Sep. 19, 2008, all of which are incorporated by reference.

### FIELD OF INVENTION

The present invention relates to human-computer interfaces, and more particularly to distributed graphical user interfaces which enable image sharing in a collaborative work space.

### DESCRIPTION OF RELATED ART

The graphical user interface (GUI) is continuously evolving to keep pace with advances in hardware and software applications. On the hardware front, touch screen systems, portable devices and smart phones raise particular challenges due to factors such as available I/O and device footprint. Still further, new yet fundamental platforms within social media and networking, and interactive and pervasive computing present the GUI and application designer further challenges. On the other hand, these advances present incredible new opportunities, some apparent and some to be discovered. One area of particular interest is sharing and collaborating on image data among a plurality of participants.

### SUMMARY OF THE INVENTION

The present invention contemplates a variety of improved methods and systems for image sharing within a collaborative work space. One embodiment provides a sophisticated GUI as a backdrop supporting a collaborative work space where a plurality of participants can interact with and view a presentation of a set of images. The presentation may optionally include an audio background. The plurality of participants each engages with their own local device having a local instantiation of the collaborative work space. In one embodiment, the local instantiation of the collaborative work space is a display block, and the GUI provides display stacks which include image content. A participant selecting and dragging the image content into the display block initiates the presentation of the set of images to all active participants, which may be a slide show displayed on all active display instantiations of the collaborative works space. A sophisticated GUI is not required in certain embodiments, but the collaborative work space can operate in a similar manner to present image presentations and optionally audio.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIGS. 1-16 illustrate a graphical user interface with a variety of different elements in various states of operation.

FIGS. 17-19 illustrate a collaborative work space for an image presentation according to certain embodiments.

FIG. 20 illustrates a collaborative work space for an image presentation according to certain embodiments.

FIG. 21 illustrates a collaborative work space for an image presentation according to certain embodiments.

### DETAILED DESCRIPTION OF THE INVENTION

The present invention contemplates a variety of improved methods and systems for image sharing within a collaborative work space. One embodiment provides a sophisticated GUI as a backdrop supporting a collaborative work space where a plurality of participants can interact with and view a presentation of a set of images, optionally with an audio background. The plurality of participants each engages with a local device having a local instantiation of the collaborative work space. In one embodiment, the local instantiation of the collaborative work space is a display block, and the GUI provides display stacks which include image content. A participant selecting and dragging the image content into the display block initiates the presentation of the set of images, which may be a slide show displayed on all active display instantiations of the collaborative works space. In another embodiment the sophisticated GUI is absent, but the collaborative work space can operate in a similar manner to present image presentations and optionally audio.

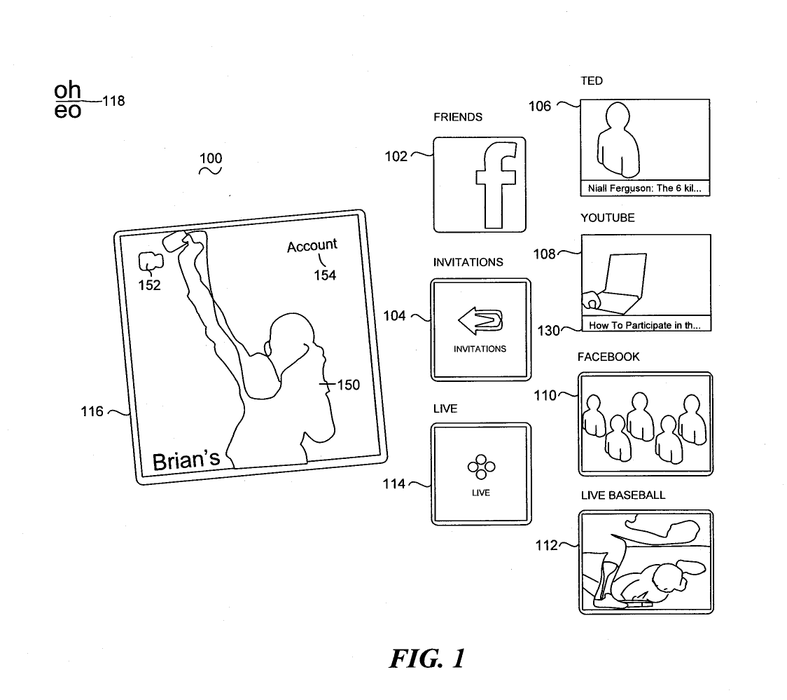

FIGS. 1-16 illustrate the mentioned sophisticated GUI, and are described now to provide a framework for one embodiment of the collaborative work space. It will be appreciated, that any variety of frameworks supporting the collaborative work space are contemplated.

FIG. 1 illustrates a graphical user interface (GUI) 100 according to an embodiment disclosed herein. In this specific embodiment, the GUI 100 is implemented on an iPad touch screen, although any computer system is conceivably suitable. For example, other smart phones, PDAs, portable computer, netbooks, etc. would be suitable. Many of the features described herein facilitate interaction with other users and participants, often remote. In these cases, the computer system would need network capability. In any event, those skilled in the art will readily understand the necessary features of the underlying computer system based upon the particular application.

The GUI 100 includes a plurality of display stacks such as contact stack 102, an invitation stack 104, a first video content stack 106, a second video contact stack 108, a social site stack 110, and a sporting site stack 112. As will be appreciated, this specific collection of display stacks is one embodiment and a variety of different combinations of types of content are contemplated. Without limitation, other display stacks may provide audio content such as radio stations, internet radio stations, or stored audio files. Other display stacks may represent an online storage collaboration platform, where various files (audio, image, document, slide shows, etc) are stored. As taught herein, the “display stack” is an elegant mechanism for managing the complexities of content, particularly in a touch screen setting where other types of human-computer interface hardware may not be readily accessible, and/or the screen may not be large relative to the amount of content involved.

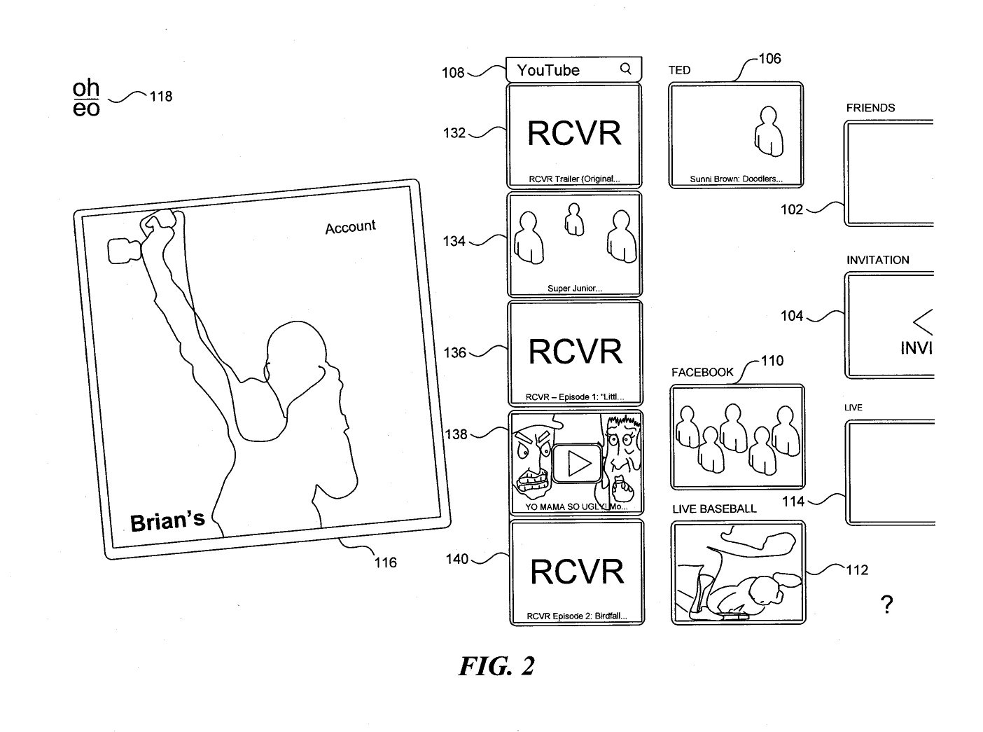

The “display stack” can take on a variety of implementations. Certain implementations of the display stack have a collapsed state and an expanded state. By way of example, the second video stack 108 is shown in FIG. 1 in a collapsed state. In contrast, the second video stack 108 is shown in FIG. 2 in an expanded state. As seen in FIG. 1, the collapsed state of the second video stack 108 is presented with a display block 130 corresponding to a specific video on top, with an appearance of a plurality of other video content display blocks stacked in a staggered manner underneath. This particular collapsed state thus provides an indication of the type of content available, as well as an indication that a plurality of content can be accessed by expanding or changing a state of the video stack 108.

With further reference to FIGS. 1-2, by a selection process, e.g. double tapping on the collapsed stack 108, the GUI 100 responds by expanding the stack 108 into a linear expanded state showing a plurality of display blocks 132-140, each corresponding to a specific video. As will be appreciated, other expanded states are contemplated. For example, the display blocks could be presented in a circle or other shape, as opposed to linearly. For this particular embodiment, the GUI 100 has the additional functionality of rearranging the GUI elements in response to expanding the stack 108, the rearrangement facilitating presentation of information and interaction with the GUI.

The stack 108 may also be scrollable, i.e., additional content may be accessed by scrolling up and/or down to additional display blocks. Rearranging to accommodate the GUI elements to improve usability, scrolling, searching and other possible features of the GUI are described in more detail below. Throughout the present discussion, reference may be made to one particular type of stack, or even a specific stack such as stack 108. As will be appreciated, the different GUI concepts described in one context are readily applicable to other stacks, depending of course on the desired implementation and suitability for the relevant underlying content in the stack.

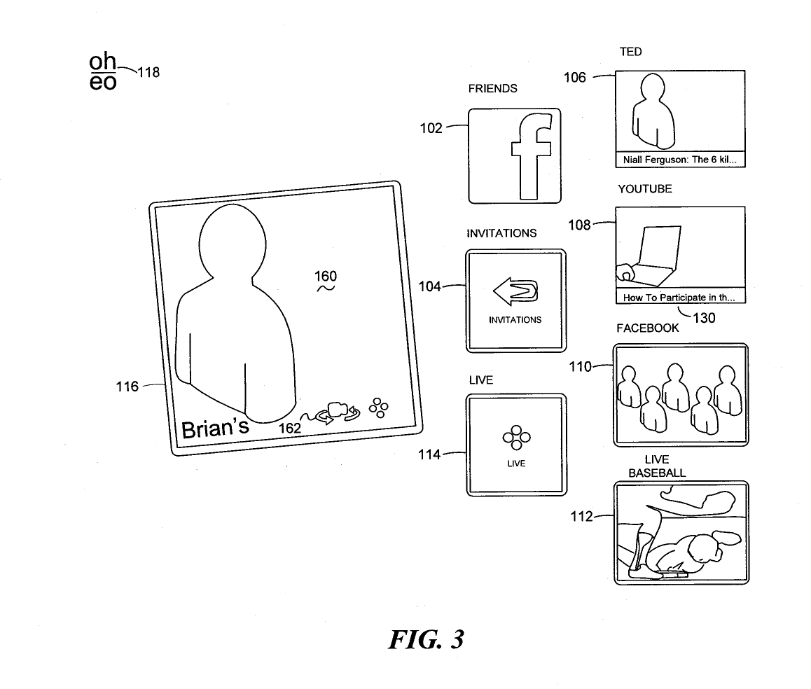

In certain embodiments, the GUI 100 includes an experience participant block 116. The experience block 116 is typically associated with a local active account and/or participant, e.g., the user logged into the GUI 100 and presumably operating the computer system. The experience block 116 has at least two states—a first state shown in FIG. 1 and a second state shown in FIG. 3. In this example, the first state 116 includes an avatar 150 associated with the local active account, a camera control button 152 for enabling the computer system camera, and an account button 154 for accessing information about the local active account. The second state 116 includes live video obtained locally, and a camera view selection button 162.

According to some embodiments, the GUI 100 provides at least two different environments. The first environment can be understood as an “explore” environment, where the local participant has access to a variety of display stacks and other functionality that facilitate activity such as exploring, searching and initiating different content, applications, and social networking. The second environment can be understood as an “experience” environment, where the local participant has initiated or joined into a particular experience such as an experience event. In each environment, different functionality is typically available.

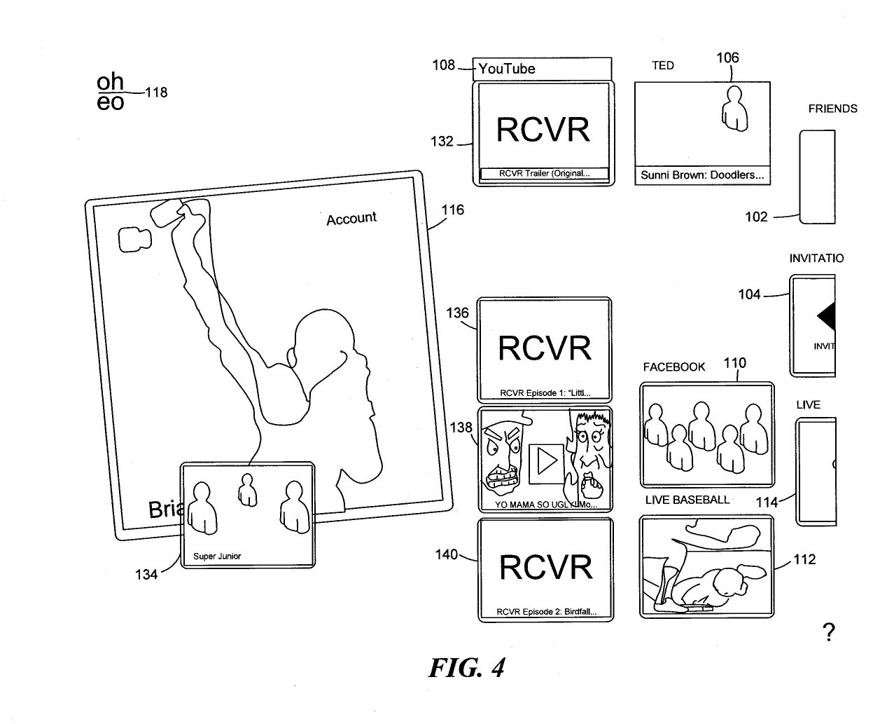

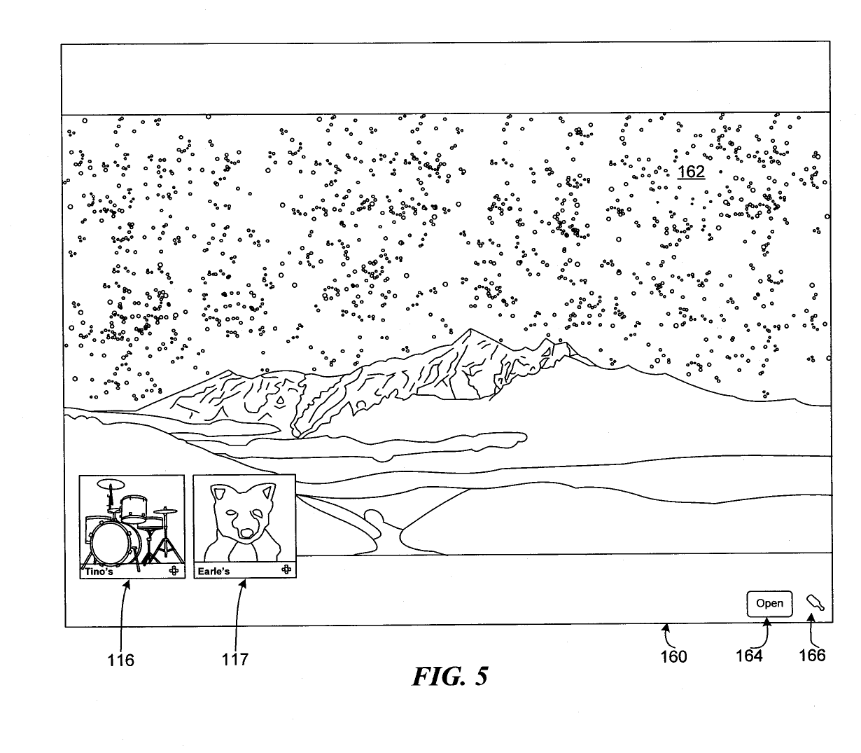

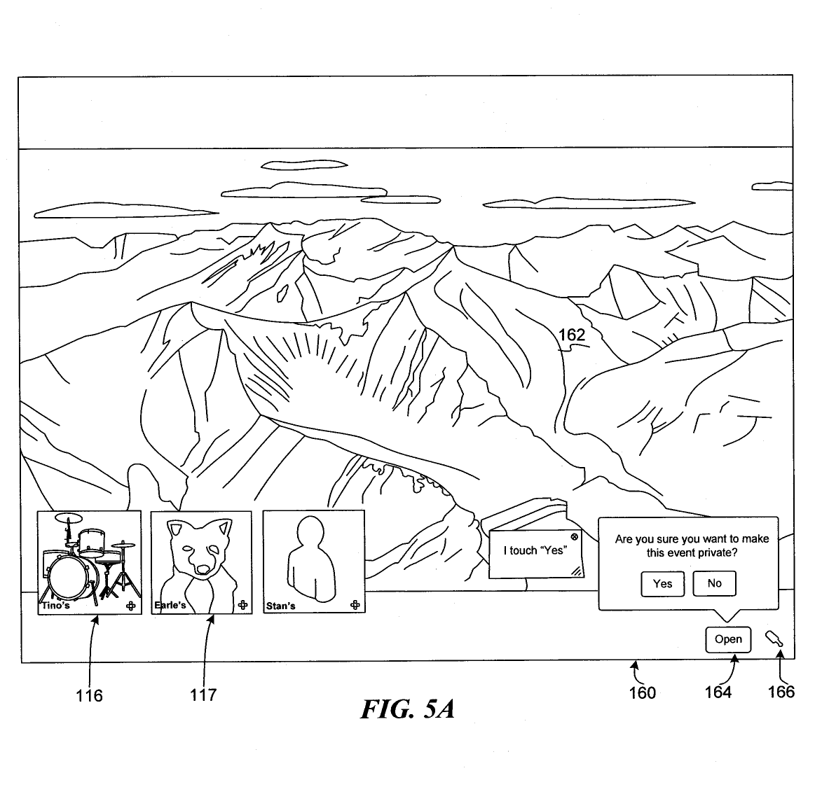

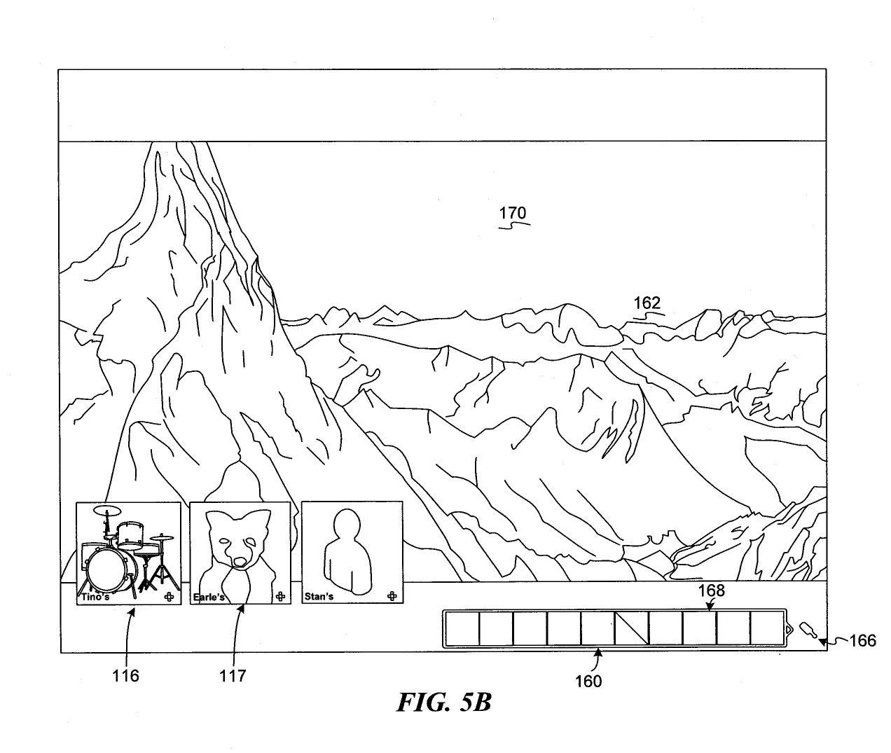

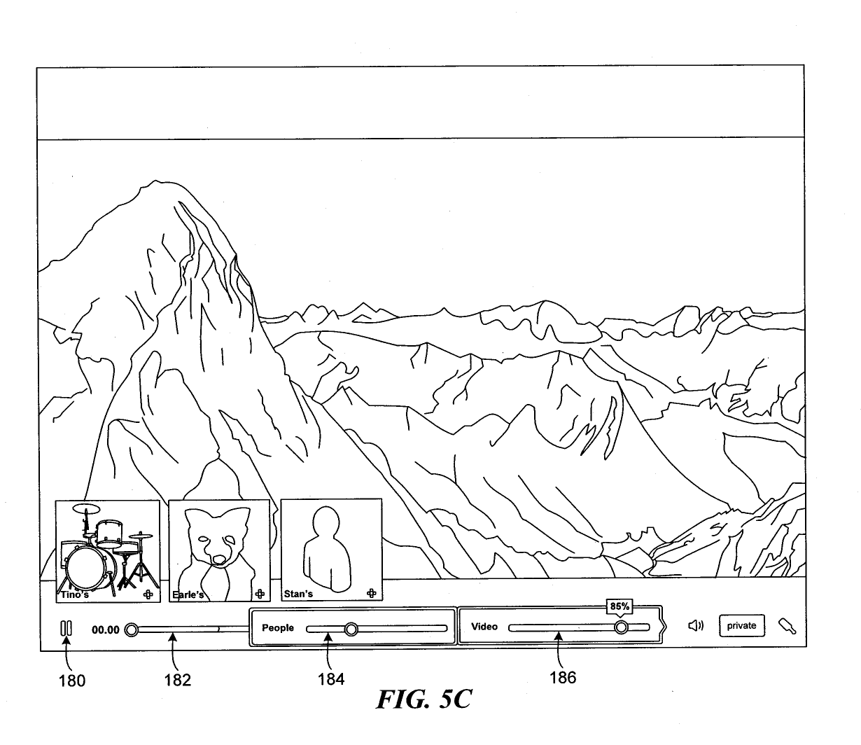

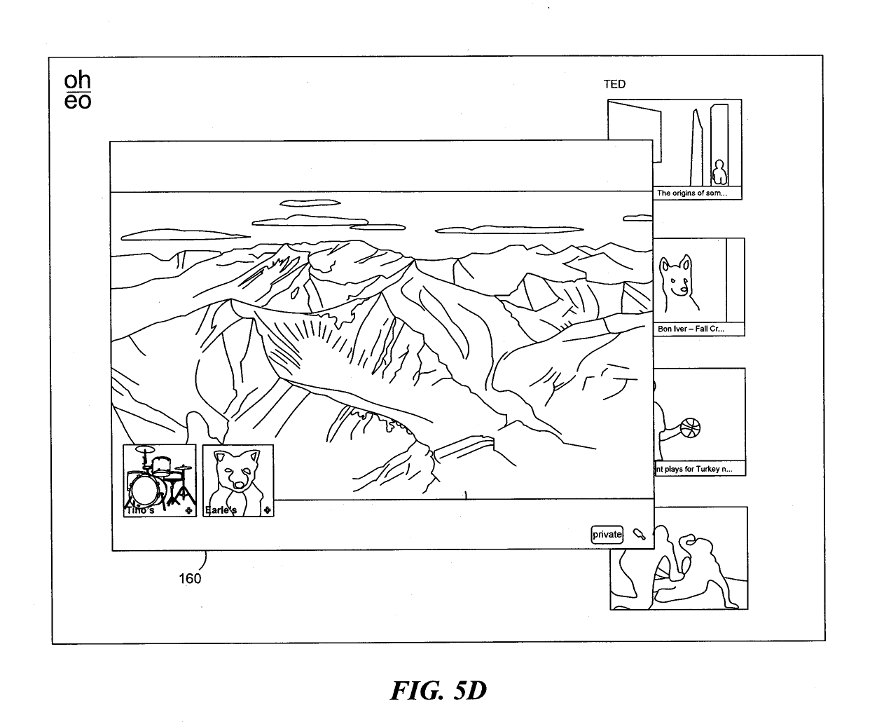

Turning next to FIG. 4, a first mechanism for moving from the explore environment and initiating an experience event will now be described. FIG. 4 illustrates the video stack 108 in an expanded state. Here the display block 134 has been selected and drug over to the participant block 116. Note that the display block 134 has transformed into a translucent state while being drug to indicate an active or selected state. Once the display block 134 is dropped into the participant block 116, an “experience event” associated with the content of the display block 134 can initiate within the participant block 116. In this specific case, the experience event begins with a YouTube® video playing as a background layer together with the participant block 116, as shown in FIG. 5. FIG. 5 illustrates an active event display block 160 which is expanded to fully occupy the available display space. This expansion could be done manually, or may be an immediate reaction to the initiation of an event.

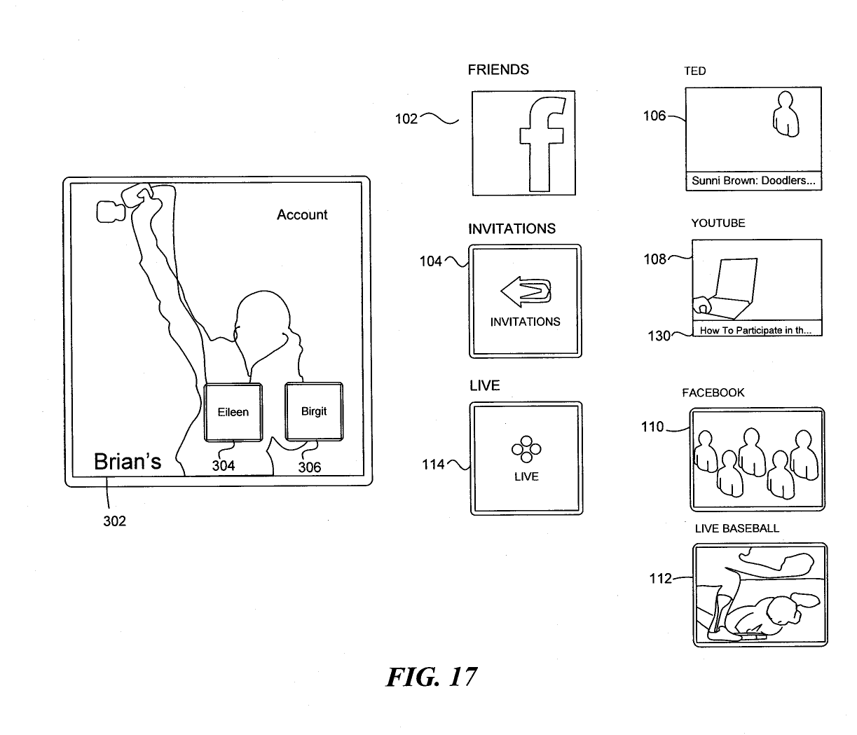

While video is used as an example here, it will be appreciated that the content could correspond to any variety of operations including opening up a webpage with the block 116, launching an application, etc. A specific type of implementation involving the presentation of photo collections with audio in a shared workspace is described below in more detail with reference to FIGS. 17-19.

A “drag to terminate,” sort of the converse of the “drag to initiate” operation, can be implemented. For example, an event may be terminated by dragging the relevant GUI element out of the participant block 116. This termination could affect the local user and/or any invitees that are participating in this event, really depending upon the nature of the event. Different participants may have different access and/or control rights. For example, in some instances only the author participant can terminate applications running in the event, or even “kick out” other participants from the event.

When an event is initiated and/or joined by the local participant, through dragging or other action, the active event display block 160 is created. As shown in FIG. 5, the event block 160 includes the participant block 116, a video layer 162, and another contact/friend block 117. As will be described in more detail below, the GUI 100 facilitates inclusion of friends and contacts into events.

In certain embodiments, within the experience environment of the event block 160 the available controls and their respected display and means of engagement are intentionally selected and/or designed to not distract from the experience. This can be accomplished in a variety of ways. For example, a variety of tools and controls such as play, scrub, volume, etc., are not shown whatsoever in a certain situations such as the embodiment of FIG. 5, and may only show when the participant touches the screen or in some other way requests their presence. These controls may remain visibly active for a predefined period of time, e.g. 5 seconds, or may stay visibly active until the participant takes a specific action, such as touching the screen again, or until a control input occurs. In the state of FIG. 5, a privacy setting button 164 and a drawing tool button 166 are displayed. The privacy setting button 164 indicates the event is in an open state. Selecting the button 164 enables the participant to change the state of the event to private, for example, a situation that all the desired participants have joined the event as seen in FIG. 5A.

FIG. 5B illustrates an event block 160 where the local participant, perhaps represented by a display block 116, has selected a drawing tool 166 initiating a “chalk talk” tool with a color palate interface 168. The chalk talk application provides a drawing layer 170 within the event block 160. Within the drawing layer 170, the local participant is providing a drawing tool and can select the color via the color palate interface 168. The specific type of drawing tool (brush, pencil, etc) may also be selectable. The GUI 100 implements the drawing layer 170 such that each user participating in the event can draw with their desired color. As shown in FIG. 5B, each display block can be implemented with a colored border, colored translucent bar, or some other suitable indicator, matching the color selected by each participant via the color palate interface. That way, it is perhaps apparent by matching the colors which participant has drawn or is drawing what. A double-tap on the screen or some other suitable command can map to an erase command.

FIG. 5C illustrates an event block 160 where the local participant has engaged further tools for controlling the experience environment. In particular, the event block 160 presents a play/pause button 180, a video slider bar and play indicator 182, a participant volume control slider bar 184, and a video volume control slider bar 186. Note that each separate layer of content or related layer of content could have unique controls. For example, an experience could involve a live video layer, and photo slide show layer, and a live commentary layer, each with their specific play and volume controls. Also, other controls like coupling display block sizing to display block volume could additionally be available within an experience. Finally, FIGS. 5D-5E illustrate an event block 160 in an active state being resized from a fully expanded state to a minimized state. This transition could be controlled by the local participant, or could be part of the experience, or could be triggered by some other activity.

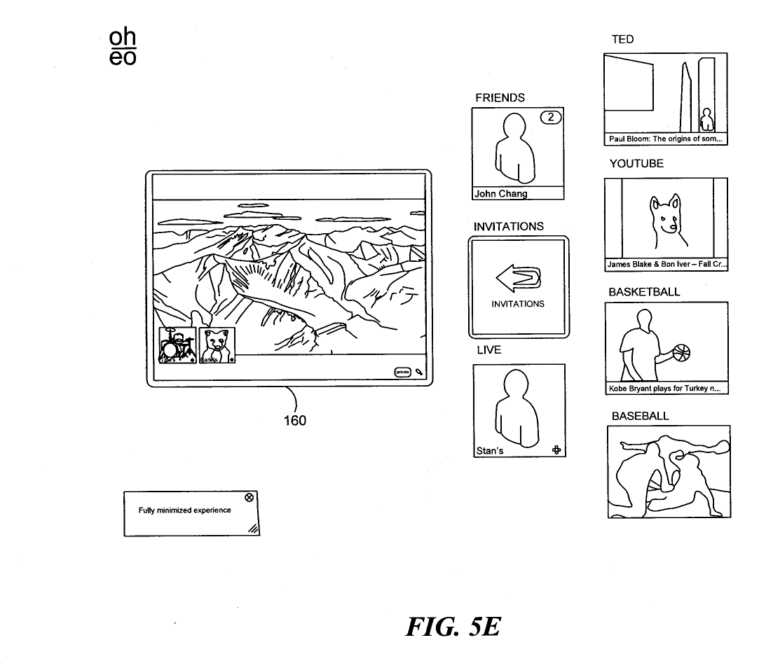

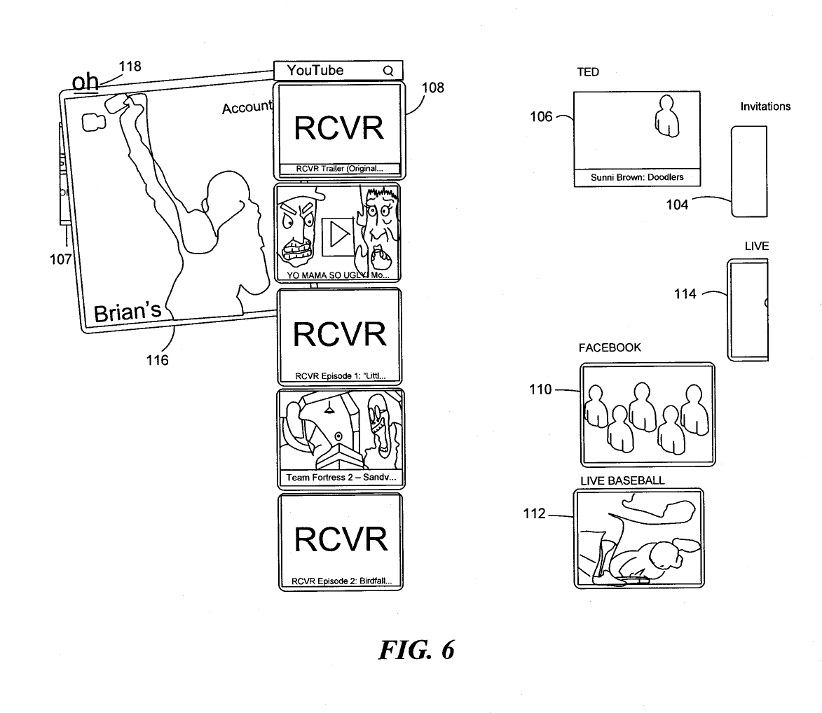

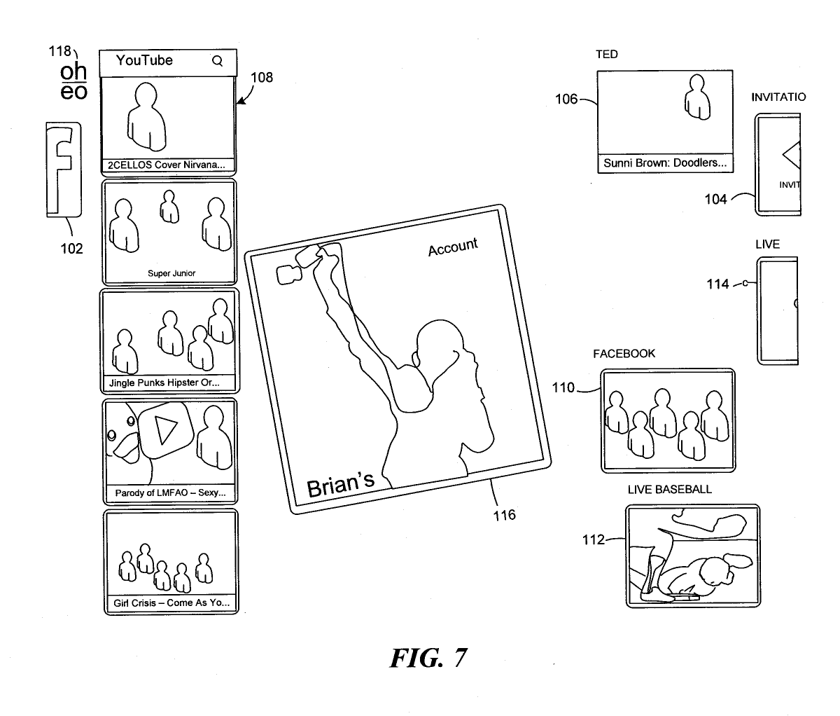

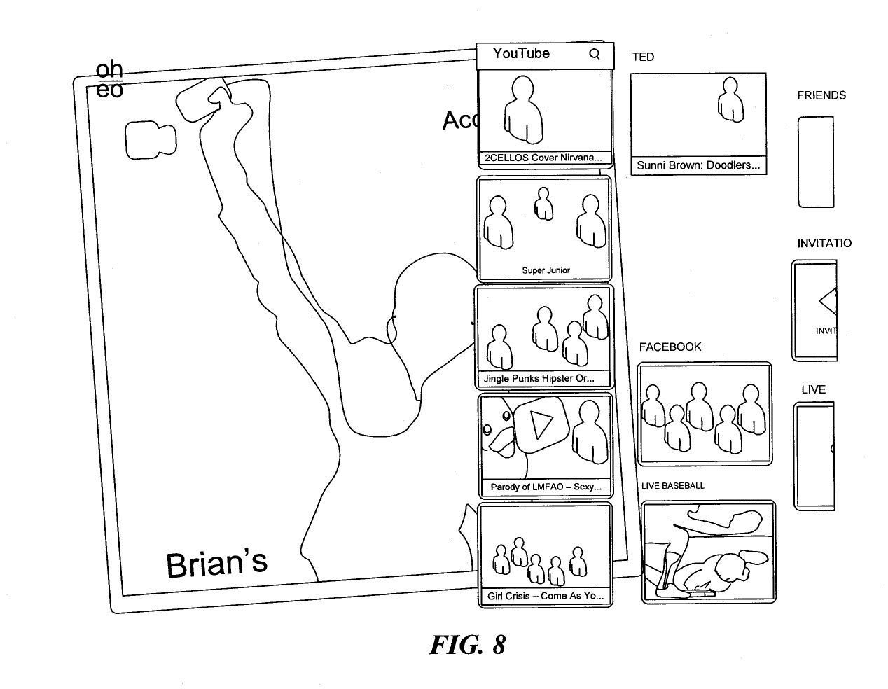

FIGS. 6-7 show another example of rearranging the elements of the GUI 100. In FIG. 6, the local participant has rearranged the elements in a manner not particularly conducive for interacting, as the participant block 116 is substantially covering one or more elements, and a video stack 108 is partially covering the participant block 116, yet there is quite a bit of “blank” space within the GUI 100. FIG. 7 illustrates the same elements arranged in a manner which may be more conducive to usability. This rearrangement of elements could occur automatically, perhaps due to a user setting. Alternatively, it is contemplated that the oheo button 118 could initiate rearrangement, either to a better arranged state as close as possible to the arrangement just prior, or to a default arrangement which could include sizing etc. One could imaging an initial selection of the oheo button 118 could rearrange into a first setting, while an second selection could then rearrange into the default arrangement, and even a third selection could result in resizing elements to default, collapsing all stacks, etc. For example, FIG. 8 shows a significantly enlarged participant block 116, with a “messy” arrangement of other elements. Selecting the oheo button 118 appropriately could result in the elements being resized, collapsed and rearranged back into a default arrangement and state, such as an arrangement of the GUI 100 as show in FIG. 1.

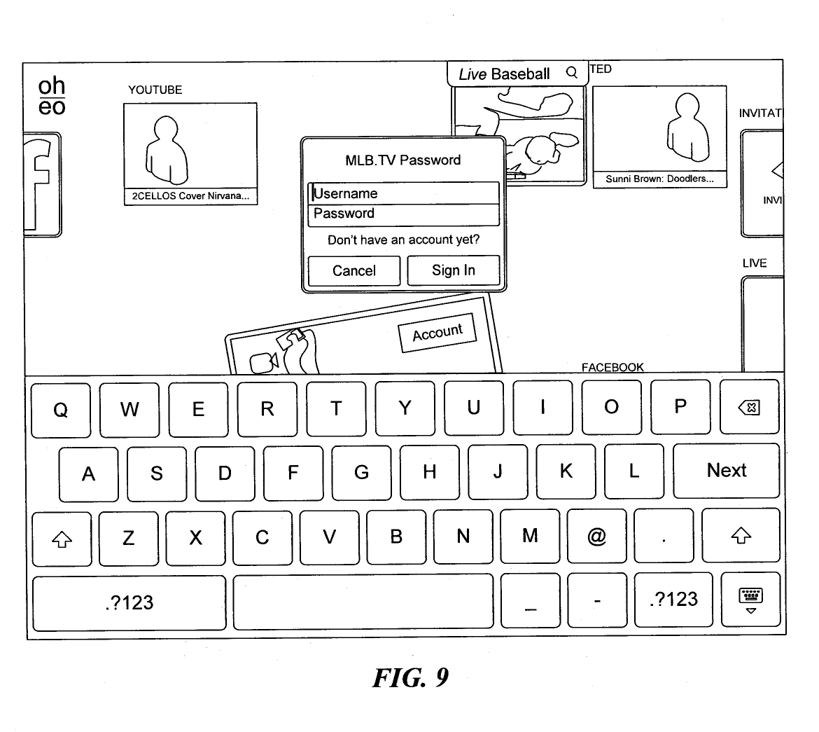

In some embodiments, initiating an event experience requires additional action beyond dragging a display block into the experience block. FIG. 9 illustrates a possible response to dragging an MLB display block 112 into the participant experience block. Specifically, as MLB TV is a members' only site, the initiating participant must sign in with a valid account—the possibility of creating an account is available. Depending upon licensing issues etc., this sign in requirement could be true for other contacts invited to join a related event. Thus accepting an invitation and/or joining an event, could require sign in by the new attendees.

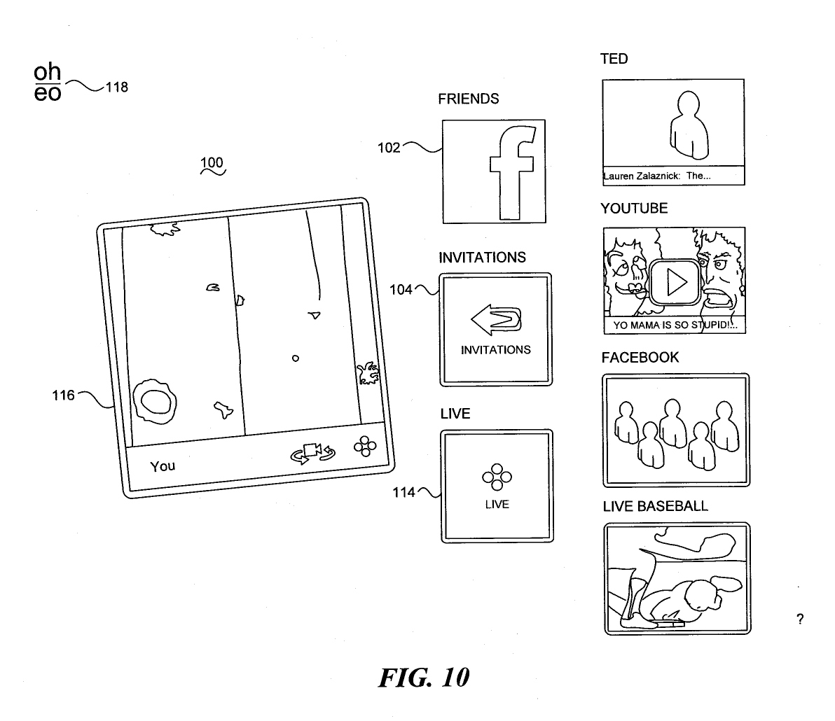

FIGS. 10-16 are now used to illustrate some capabilities of a contact stack 102, an invitation stack 104, and a live stack 114, as well as their interoperability with each other and other elements of a GUI 100 according to one embodiment. Some embodiments provide mechanisms for connecting with social contacts, inviting friends and/or contacts to participate in events, joining events (public and/or by invitation), initiating events, etc.

In FIG. 10, the contact stack 102, the invitation stack 104, and the live stack 114 are each in a collapsed state, and provide a neutral display indication. That is, no particular further information is indicated by the stacks in this state. In some embodiments, this neutral state indicates that there are no friend requests (received and/or outstanding), no pending invitations (received and/or outstanding), and no live events we may join (public or private). However, in other embodiments the collapsed state is always neutral, e.g., there is no further particular information to be found in the display.

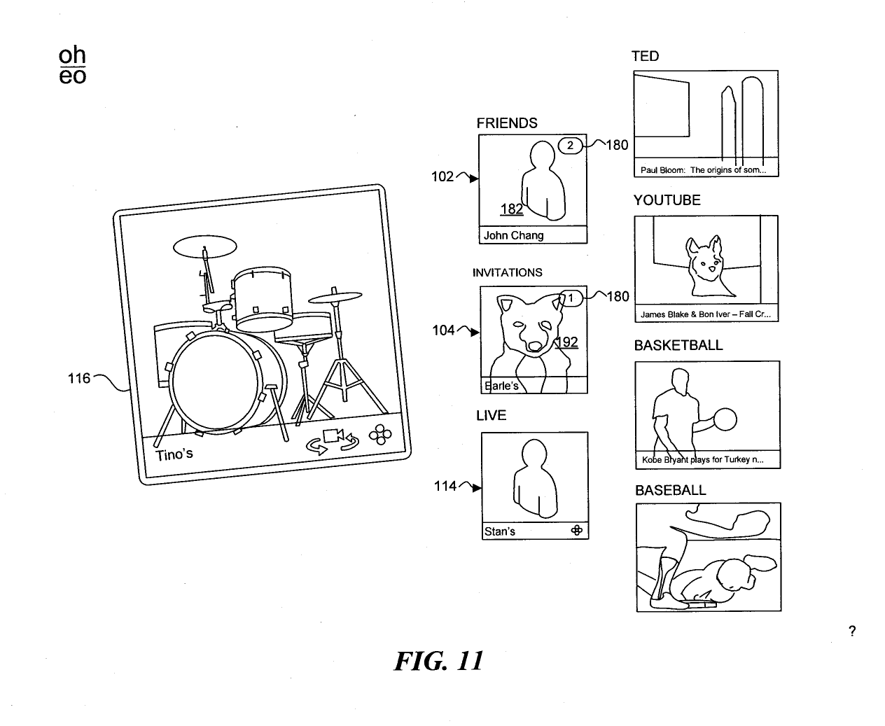

In contrast, FIG. 11 illustrates a situation where further information is available in these three stacks. The contact stack 102 indicates at icon 180 that two friend requests are pending, and an image 182 indicates that one of the pending friend requests relates to “John Cheng.” The invitation stack 104 indicates at icon 190 that there is one invitation pending, and an image 192 indicates that the invitation relates to “Earle.” The live stack 114 indicates that there is at least (or only, depending upon the rule) one live event which the local participant can join, and that this event is hosted or initiated by “Stan.” Note that the live stack 114 doesn't present an icon corresponding to the number of live events available to the local participant. This is intended to highlight the arbitrary nature of arranging the interface, i.e., that different embodiments can present the stacks and provide different functionality as desired by the application. The lack of an icon could specifically indicate there is only one available event to join, or could simply mean no such information is displayed. Furthermore, actions like the pending friend invitations could be invitations initiated by the local participant, invitations received by the local participant, or both. The same is true for the other stacks.

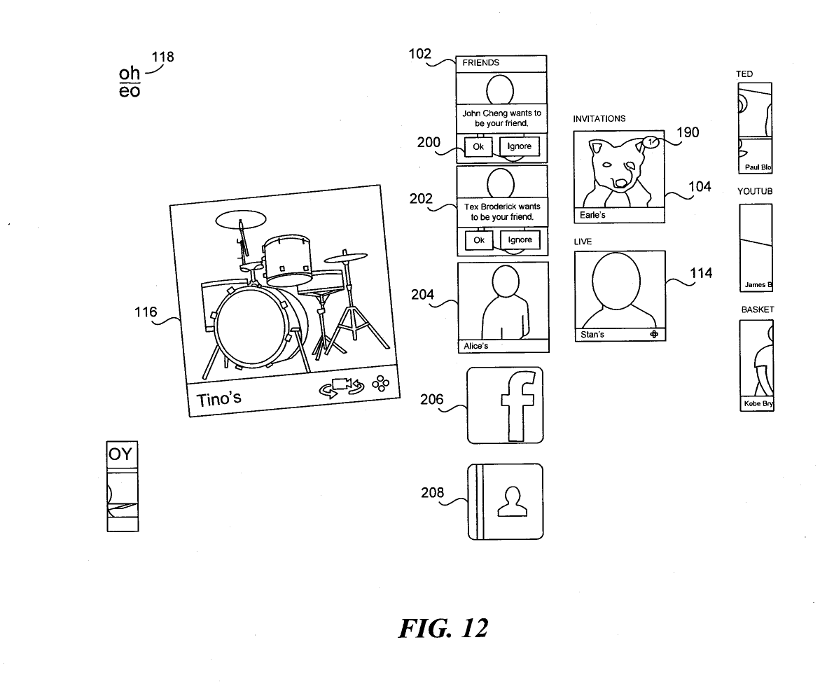

In FIG. 12, the contact stack 102 has been selected and in response has transitioned into an expanded state. (As an aside, note that the elements of the GUI 100 have disposed themselves into an arrangement more conducive to interaction.) The contact stack 102 here has display blocks 200-208. Display blocks 200 and 202 indicate that “John Chang” and “Tex Broderick,” respectively, want to connect as friends. Display block 204 indicates that “Alice” is already a connected friend. Display blocks 206 and 208 indicate two social networking sites (e.g., Facebook® or LinkedIn®) are accessible for inviting friends into Oheo™, one of the applicant's experience platforms associated with the GUI 100.

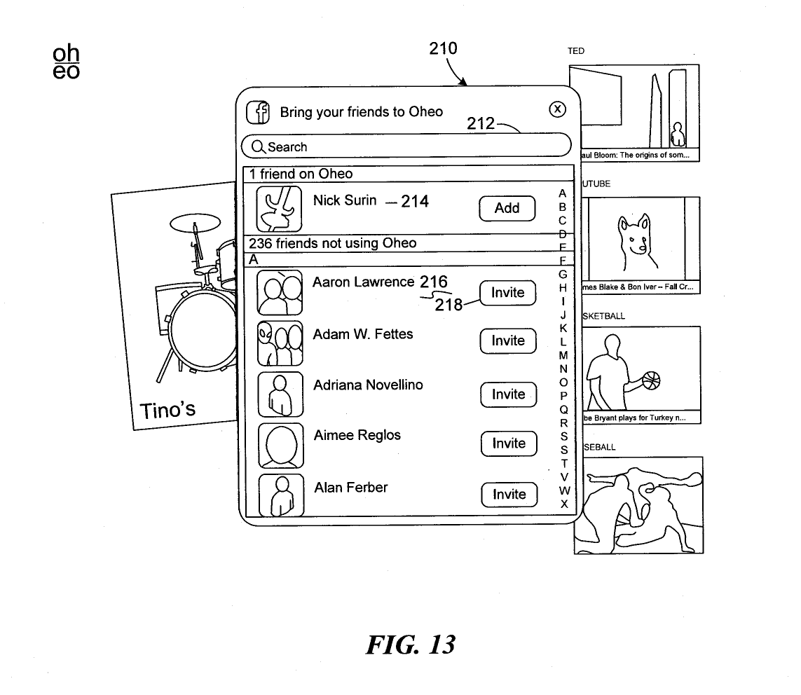

In FIG. 13, display block 208 corresponding to a Facebook account has been selected and in response a display block 210 has expanded and become active. The display block 210 could take any suitable form, in FIG. 13 it provides a search bar 212, a list 214 of friends already on Oheo, and an alphabetical and scrollable selection window 216, where each friend has an image, text and invite button 218, associated therewith.

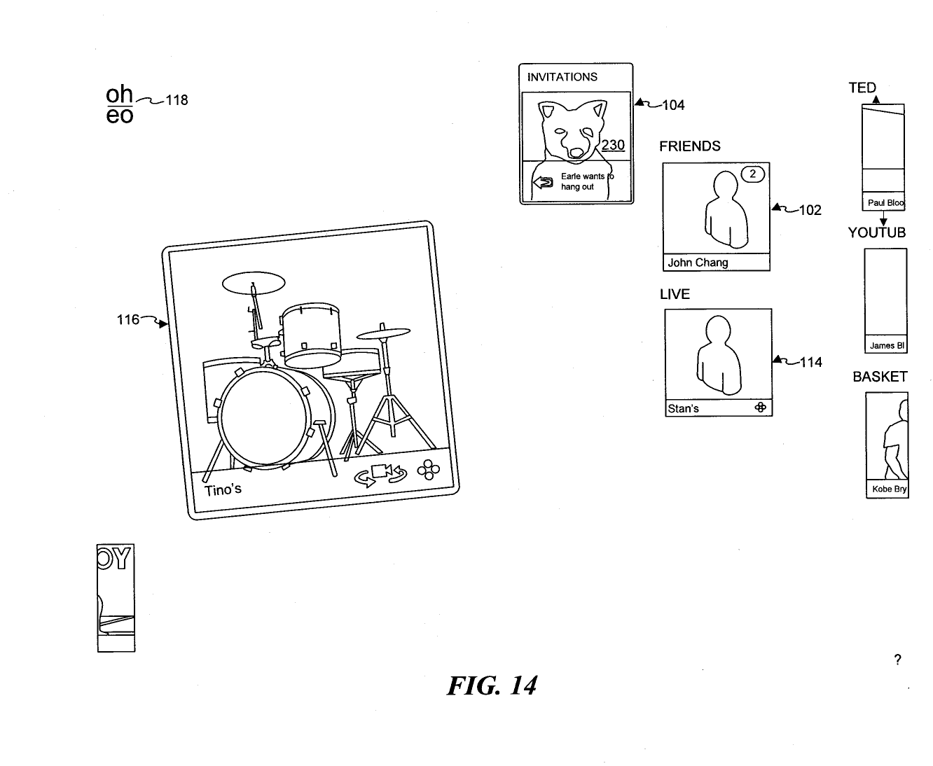

In FIG. 14, invite stack 104 has been selected and in response has transitioned to an expanded state. (Again, elements have rearranged accordingly.) In the expanded state of invite stack 104, a display block 230 indicates that “Earle wants to hang out” which in one embodiment means Earle is inviting the local active participant to join in an event, which may either be currently pending, may be scheduled for a future preset time, or may only be initiated upon a certain set of conditions arising—e.g., an invitee joining accepting an invitation.

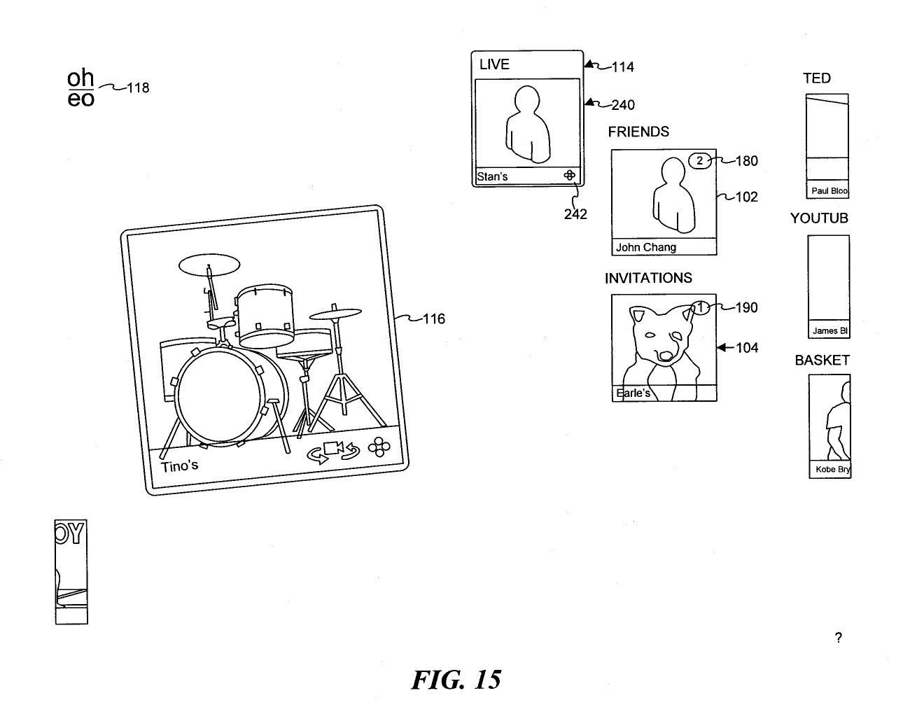

In FIG. 15, live stack 114 has been selected and in response has transitioned to an expanded state. (Again, elements have rearranged accordingly.) In the expanded state of live stack 114, a single event is available and shown as a display block 240 indicating an event initiated by “Stan” is available to the local user. Also in the display block 240 is a spin icon 242 which indicates some characteristic of “Stan's” event. In this instance particularly, the spin icon 242 is green, indicating an event that is open to friends. Other colors and or shapes may indicate different aspects, such as private or invitation only, public events, pay per view events (say, a $$ symbol), specific membership required to participate (say, an MLB logo), etc. Note that such symbols could also be available on other invitations, notices, display blocks, etc.

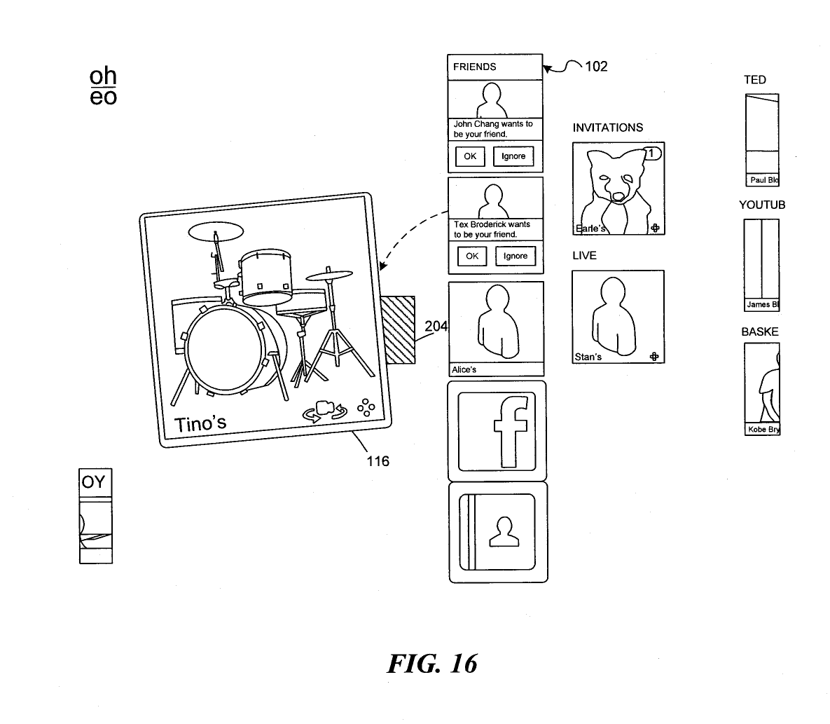

FIG. 16 is now used to illustrate one mechanism for inviting friends and/or contacts to join in an experience event. In FIG. 16 the contact stack 102 is shown in an expanded state with a plurality of contact display blocks such as contact block 200. A local participant can select and drop the contact block 204 within the local event experience block 116. This action triggers an invitation to the contact or friend associated with the contact block 200 to join in an active (or scheduled) experience. In some embodiments, the selection and dragging process would place the contact block 200 into a translucent state to indicate actively selected.

By comparing the miscellaneous view present above, it is apparent that the applicant's GUI 100 has rearranged the elements of the interface to accommodate for each action along the way resulting in the expanded state of the invitation stack 104. Typically the GUI 100 would rearrange elements in a logical fashion to improve usability. For example, selecting and expanding the invitation stack 104 tends to indicate this element should be displayed prominently, as well as any other stacks and/or blocks that might be related to event invitations, or whatever makes the best sense in the specific circumstances. Other situations may result in an expanded stack collapsing under suitable conditions. For example, initiating an application through an application block from expanded application stack may result in the application stack collapsing once the application is started—presumably, the user has the desired application so the stack can collapse. This behavior could of course be controlled or influenced by settings in the local user account.

With reference to FIGS. 17-19, several embodiments for sharing images within a collaborative workspace will now be described. FIG. 17 illustrates a graphical user interface (GUI) 300 that provides image sharing and supporting functionality within a collaborative work space. In this specific embodiment, the GUI 300 is implemented on an iPad touch screen, although any computer system is conceivably suitable. For example, other smart phones, PDAs, portable computer, netbooks, etc. would be suitable. Many of the features described herein facilitate interaction with other users and participants, often remote. In these cases, the computer system would need network capability. In any event, those skilled in the art will readily understand the necessary features of the underlying computer system based upon the particular application. More details about the GUI operation have been described above and will not be repeated here, but suffice it to say, the elements illustrated in these specific FIGS. may have a similar operation as described above, and/or a suitable functionality as now described or should be apparent to those skilled in the art.

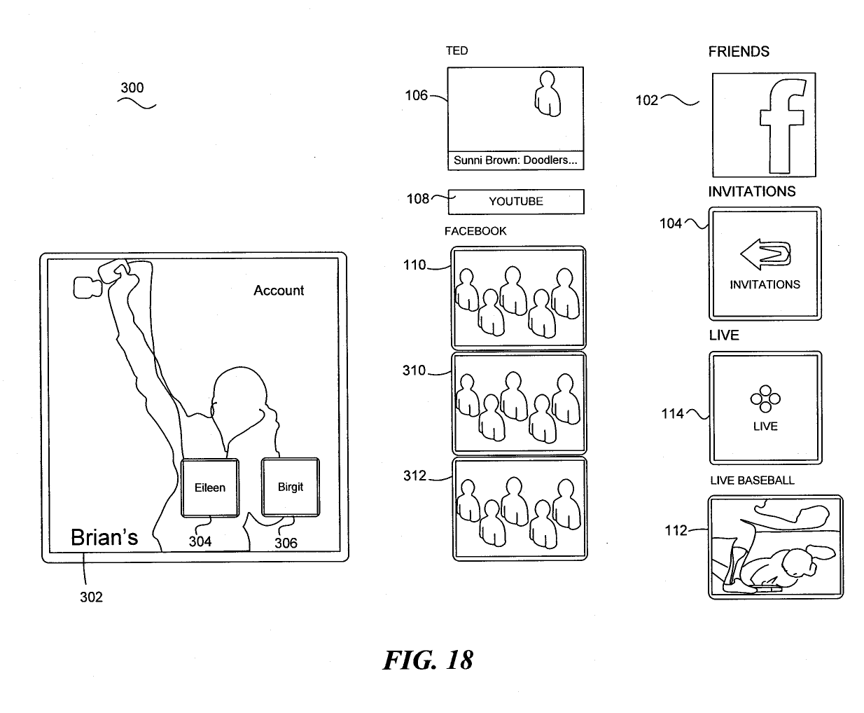

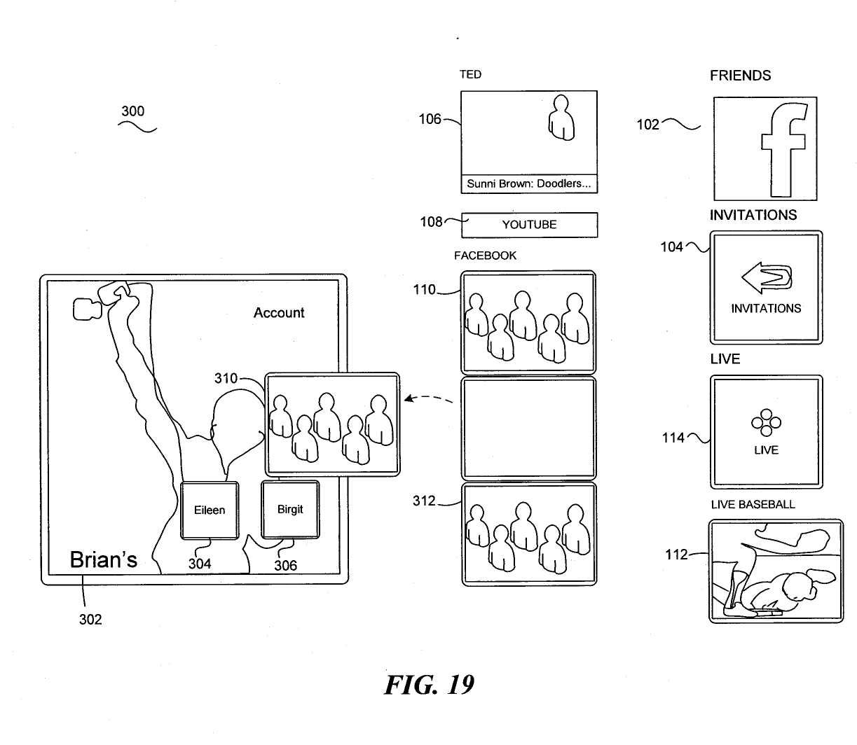

FIGS. 17-19 show an experience participant block 300 with active contact blocks 304 and 306. Here an experience event is already underway, with the local and two remote participants engaged. In FIG. 18, the local participant has expanded the social media stack 110 into a linear expanded state showing a plurality of display blocks 310 and 312. The display block 310 in particular corresponds to a set of photographs available in a database corresponding to the social media stack 110. As shown in FIG. 19, the local participant drags the display block 310 into the experience participant block 300. In response to this drag and activation of the display block 310, a slide show or other type of image presentation event is initiated within the experience participant block 300. The active participants will now all be able to see the slide show, thus providing image sharing in a collaborative work space.

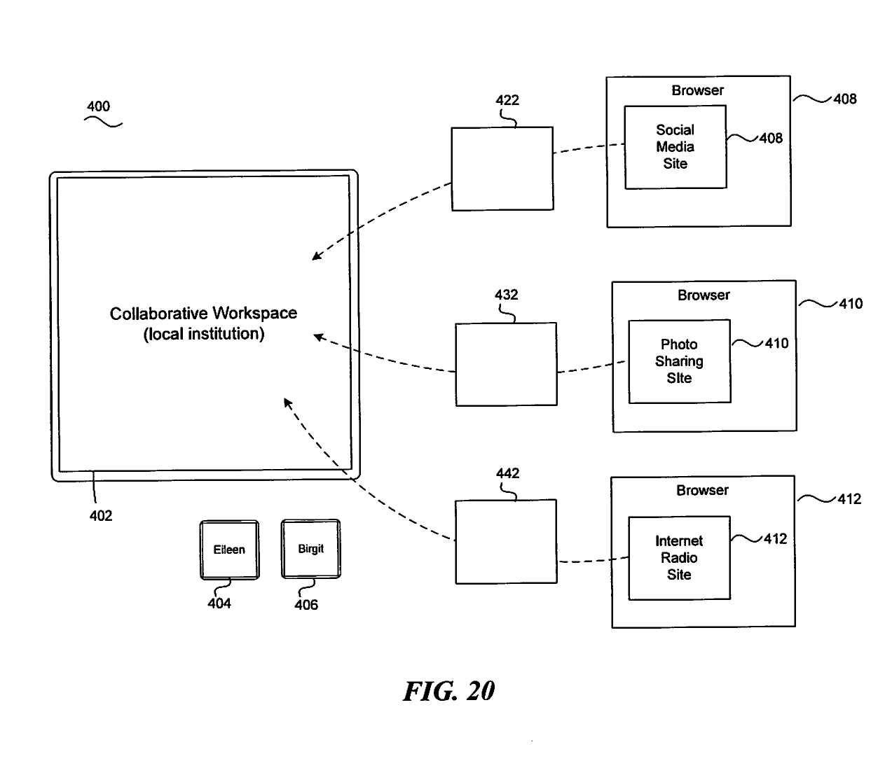

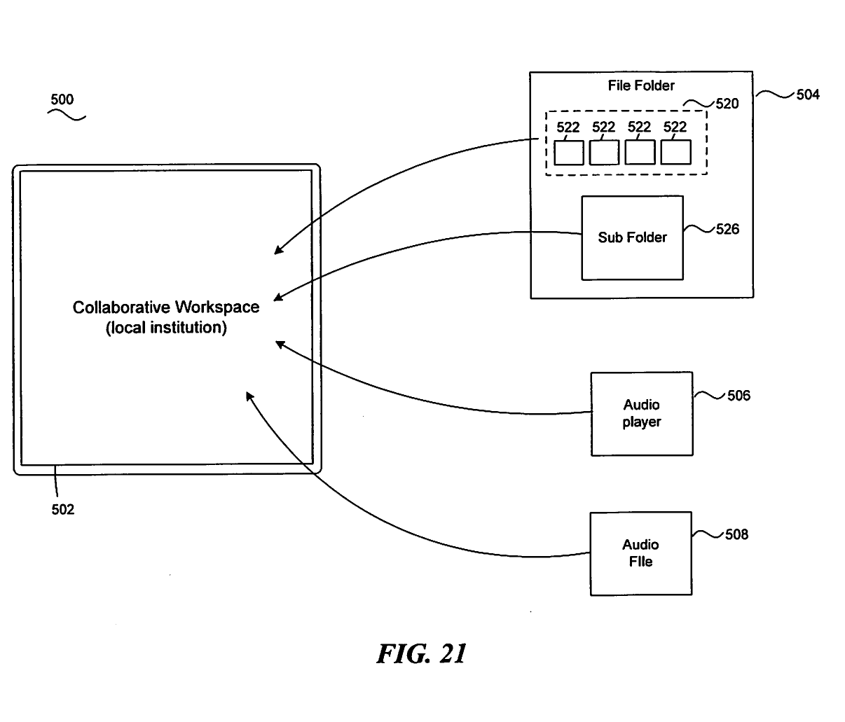

The image sharing embodiments of FIGS. 17-19 incorporated the sophisticated GUI described above with reference to FIGS. 1-16. However, other image sharing embodiments don't rely on any particular GUI, but operate in any suitable framework, including typical prior art computer interfaces, etc. Several additional embodiments are described below with reference to FIGS. 20-21. It is contemplated that the varying functionality and appearance among the different figures and related description can be combined in any manner and the present invention is not limited by any specific combination illustrated and/or described herein.

FIG. 20 illustrates an embodiment for image sharing in a shared work space. An interface 400 includes a collaborative work space 402, video chat windows 404 and 406, and a plurality of browsers 408—412. The collaborative work space 402 represents a local participant's instantiation of the collaborative work environment, and video chat windows 404 and 406 represent other active participants. As will be appreciated, video chat windows 404 and 406 are in fact optional. Further, more participants could be invited to join. Other participants may be active, but without a device supporting video-chat capabilities. In this case, an avatar representing the participant may be displayed, a simple icon, or nothing at all.

With further reference to FIG. 20, the browser 408 has been navigated to a social media site 420 where an image collection 422 has been selected and is being drug into the collaborative work space 402. This selection and drag action will initiate a slide show, or other suitable presentation, of the image collection 422, in the collaborative work space 402. The browser 410 has been navigated to a photo sharing site 430 where a collection of photos 432 has been selected and is being drug into the collaborative work space. This selection and drag action will initiate a slide show, or other suitable presentation, of the collection of photos, in the collaborative work space 402. The browser 412 has been navigated to an internet radio site 440 where a song collection or a radio station 442 has been selected and is being drug into the collaborative work space 402. This selection and drag action will initiate an audio background or soundtrack being played in the collaborative work space 402.

FIG. 21 illustrates another embodiment for image sharing in a shared work space. An interface 500 includes a collaborative work space 502, an open file folder 504, an active audio player 506, and an audio file 508. The interface 500 may be the desktop of a personal computer, or any suitable interface. From the open file folder 504, a collection 520 of photographs 522 has been selected and is being drug into the collaborative work space 502, which action will initiate a slide show or other suitable presentation of the photographs 522. Also from the open file folder 504, a subfolder 526 has been selected and is being drug into the collaborative work space 502, which action will initiate a slide show or other suitable presentation of any images from the subfolder 526. The active audio player 506 has been selected and is being drug into the collaborative work space 502, which will cause audio originating from the active audio player 506 to play within the collaborative work space 502. Similarly, the audio file 508 has been selected and is being drug into the collaborative work space 502, which will cause the audio file 508 to begin playing within the collaborative work space 502.

In certain embodiments, a wide range of functionality can be provided. For example, the local participant may drag in a sound track from a video or audio stack, or other suitable source. The other participants may be allowed to drag in images from their explore area. These new images could be added to the slide show or take over the slide show, depending upon the logic of execution in the specific implementation. Thus, the participants can collaborate in creating an experience. The ability of certain participants may be limited, either based on settings, network capabilities, and/or device capabilities.

The image sharing experience may include providing operational controls to the local and or other experience participants. These operational controls could include stop, pause, skip, adjust speed and/or volume, etc. This could also include editing functions, providing for a collaborative creation of a slide show or other image presentation.

As will be appreciated, illustrating multiple actions in a single figure or across multiple related figures, does not necessarily indicate that such actions are performed simultaneously or all in one event. Instead, these varying actions are shown as possible examples or variations. For example, with reference to FIG. 21, multiple picture collections and multiple audio data are drug into the work space, only as an example of what actions may be suitable, not to imply all four specific actions occurred in an event or are required for an embodiment. Of course, all four actions could be taken, and many different actions can be performed together in any suitable order in any event.

Vonog et al's U.S. patent application Ser. No. 12/564,010, entitled “METHOD AND SYSTEM FOR DISTRIBUTED COMPUTING INTERFACE,” and filed Sep. 21, 2009, is incorporated by reference. Vonog et al's '010 application teaches various methods, frameworks, computer architects and devices, that are well suited for providing collaborative work spaces such as those described in more specific detail herein.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

I claim:

1. A computer implemented method for providing a graphical user interface for a computer system, together with image sharing functionality in a collaborative work space, the method comprising:
generating an experience block corresponding to a local active account, the experience block being a local instantiation of a collaborative work space available for access by a plurality of participants;
generating a first display stack, the first display stack including a first plurality of display blocks corresponding to content, the first display stack having a collapsed state and an expanded state, a specific display block of the first plurality of display blocks corresponding to a set of images;
switching display states of the first display stack, in response to input controls received at the graphical user interface, wherein:
when the first display stack is in the collapsed state, a collapsed state image is displayed which is minimized in size and does not display all the first plurality of display blocks, and provides a visual clue that content is available within the first display stack;
when the first display stack is in the expanded state, an expanded state image is displayed which includes images associated with each of the first plurality of display blocks;
in response to the specific display block being engaged in a defined manner by a first participant, presenting the set of images within the experience block, the presentation of the set of images within the experience block available to the plurality of participants.

2. A computer implemented method as recited in claim 1, wherein the presenting includes displaying a slide show of the set of images.

3. A computer implemented method as recited in claim 1, wherein engaging the specific display block in the defined manner includes:
selecting the specific display block; and
dragging the specific display block into the experience block.

4. A computer implemented method as recited in claim 1, further comprising:
enabling a participant to include audio coupled with the presentation of the set of images.

5. A computer implemented method as recited in claim 1, further comprising:
enabling the first participant to couple audio with the presentation of the set of images;
in response to a particular image display block being selected and dragged into the collaborative work space, incorporating images associated with the particular image display block into the presentation of the set of images.

6. A computer implemented method as recited in claim 1, wherein a second display stack represents a collection of friends of the local active account, and each of a second plurality of display blocks corresponds to a specific friend.

7. A computer implemented method as recited in claim 6, wherein a third display stack represents a collection of pending experience invitations, and each of a third plurality of display blocks corresponds to a specific invitation.

8. A computer implemented method as recited in claim 1, wherein a second display stack represents a collection of applications available for execution on the computer system, and each of a second plurality of display blocks corresponds to a specific application.

9. A computer implemented method as recited in claim 1, the method further comprising:
generating and displaying a second display stack, the second display stack including a second plurality of display blocks, each display block corresponding to a contact;
responding, to a given display block from the second plurality of display blocks being selected and moved into the experience block, by inviting a given contact associated with the given display block to join in the first experience.

10. A computer implemented method as recited in claim 9, the method further comprising:
responding to the given contact accepting the first experience invitation by bring the given contact into the experience, including displaying a given display block representative of the given contact within the experience block.

11. A computer implemented method as recited in claim 10, the method further comprising:
responding to the given display block being selected and moved out of the experience block by ending the given contact's participation in the first experience.

12. A computer implemented method for providing a graphical user interface for a computer system, the method comprising:
generating and displaying a plurality of display stacks, wherein each specific display stack includes a plurality of display blocks, the specific display stack has a collapsed state and an expanded state, wherein when the specific display stack is in the collapsed state, a collapsed state image is displayed minimized in size and does not display all the plurality of display blocks, and the collapsed state image provides a visual clue that content is available for expansion within the specific display stack, and when the specific display stack is in the expanded state, an expanded state image is displayed which includes images associated with each of the plurality of display blocks;
switching display states of each display stack, in response to input controls received at the graphical user interface;
providing a first display stack representing image content where each display block corresponds to a specific image;
providing a second display stack representing a plurality of contacts where each display block corresponds to a specific friend;
providing a third display stack representing a plurality of event invitations where each display block corresponds to a specific invitation.

13. A computer implemented method as recited in claim 12, further comprising:
coupling the first display stack with searchable content;
providing a search tool associated with the first display stack;
receiving a search request via the search tool;
presenting search results as display blocks within the first display stack.

14. A computer implemented method as recited in claim 12, further comprising:
generating a collaborative work space where a plurality of users can interact;
receiving a selection of a specific display block corresponding to a set of images;
in response to the selection of a specific display block corresponding to the set of images, initiating a slide show of the set of images within the collaborative work space.

15. A computer implemented method as recited in claim 14, further comprising:
receiving a selection of a given display block corresponding to audio;
in response to the selection of a given display block corresponding to audio, incorporating the given audio into the collaborative work space to accompany the slide show.

16. A computer implemented method as recited in claim 14, further comprising:
receiving a selection of a given display block corresponding to a second set of images;
in response to the selection of the given display block corresponding to the second set of images, incorporating the second set of images into the slide show.

17. A computer implemented method as recited in claim 16, wherein the first and second set of images are selected by different participants.

18. A computer system comprising:
a processing unit:
memory;
a network device;
a bus coupling the processing unit, the memory and the network device;
a first module for generating a first display block corresponding to a local instantiation of a collaborative work space;
a second module for generating a first display stack, the first display stack including a first plurality of display blocks corresponding to image content, the first display stack having a collapsed state and an expanded state;
a third module responsive to a selection of a specific display block to initiate a slide show of the image content within the first display block; and
a collaborative work space module performing local actions required to provide the collaborative work space with the slide show to a plurality of remote devices.

19. A collaborative work space comprising:
a plurality of computing devices;
a plurality of display blocks, at least one display block instantiated on each one of the plurality of computing devices;
a plurality of local instantiations of the collaborative work space on each of the plurality of computing devices, wherein each display block represents the local instantiation of the collaborative work space;
a first module responsive to a selection of a first set of images to initiate a presentation of the first set of images within the collaborative work space, including displaying the presentation within the plurality of display blocks;
a second module response to a selection of audio content to initiate playing the audio content at each of the plurality of computing devices as a background sound track to the presentation of the first set of images.

20. A collaborative work space as recited in claim 19, wherein the presentation of the first set of images is a slide show of the first set of images.

21. A collaborative work space as recited in claim 20, wherein at least one local instantiation of the collaborative work space includes a third module enabling control of the slide show and audio content.

22. A collaborative work space as recited in claim 23, wherein each local instantiation of the collaborative work space includes instantiations of the first and second modules, such that each device can collaborate actively in the presentation of content.
